(19) United States
(12) Patent Application Publication
(10) Pub. No.: US 2012/0062932 A1
(43) Pub. Date: Mar. 15, 2012

(54) ANTI-ALIAS PROCESSING WITH LOW-RESOLUTION IMAGE

(76) Inventor: Christopher Rueby, North Chili, NY (US)

(21) Appl. No.: 12/878,295

(22) Filed: Sep. 9, 2010

(51) Int. Cl. G06F 3/12

(52) U.S. Cl. 358/1.15

(57) ABSTRACT

A method for printing low-resolution digital image data received from a host computer on a digital printer, comprising: receiving low-resolution image data; receiving mask image data, wherein the mask image data is formed by automatically analyzing the full-resolution image data or the low-resolution image data, the mask image data providing an indication of image regions in the low resolution image data that would benefit from the application of an anti-aliasing algorithm; using a data processor in the digital printer to resize the low-resolution image data, forming high-resolution image data at a higher resolution than the low-resolution image data; using the data processor in the digital printer to apply an anti-aliasing method to portions of the high-resolution image data corresponding to the indicated image regions in the mask image data, thereby providing anti-aliased image data; and printing the anti-aliased image data on the digital printer.

### FIELD OF THE INVENTION

This invention pertains to the field of forming digital images and more particularly to a method for processing low-resolution image data to provide anti-aliasing of text and line art elements.

### BACKGROUND OF THE INVENTION

Continuing improvements in the design and performance of printing apparatus, such as for lower cost ink jet printers, present challenges and create a need for image processing methods that take advantage of these advancements. Printer resolution, for example, has improved, along with more standardized methods and utilities for efficient printer interface and image transfer.

Among the improvements for directing image data to the printer are wireless transmission. Conventional wireless data transfer typically uses a wireless networking technology based on the Institute of Electrical and Electronics Engineers (IEEE) 802.11 standard, generally termed “WiFi,” or some other wireless local area network (LAN) standard. Adoption of this and similar standards facilitates the convenient connection of a wide variety of devices. Thus, for example, images from a host computer, a broad category that can include cell phone, personal digital assistant (PDA), or numerous other desktop or portable devices, can be directed to a printer without requiring a cable interconnection and without requiring extensive configuration activities by the user.

One acknowledged drawback of wireless communication relates to the speed of data transmission. Even in an ideal environment, wireless transfer of image data from a host computer can take considerably longer than transfer of a comparable data set when using a cable.

In a wireless printing configuration where multiple host computer devices can print to a printer, each host computer device has a host driver that renders the image for transmission to the printer. In many cases, to reduce data transmission times, the rendered image data may be transmitted to the printer at a resolution lower than the final resolution of the printer hardware itself. This results in a number of imaging problems, including the problem of image aliasing effects. Image aliasing is a well-known problem caused by image sampling. Artifacts resulting from image aliasing include irregular edges for text and line graphics, aptly termed “jaggies.”

The schematic block diagram of FIG. 1 shows an arrangement of components for a representative printing system architecture. At a host computer 10, an input digital image 12 is processed by a rendering engine 20 to provide a rendered digital image 22. The input digital image 12 typically includes an array of input image pixels for each of a plurality of input color channels (e.g., a red input image plane 13R, a green input image plane 13G and a blue input image plane 13B). The rendered digital image 22 will likewise include an array of rendered image pixels for each of a plurality of rendered color channels (e.g., a red rendered image plane 23R, a green rendered image plane 23G and a blue rendered image plane 23B).

The rendering engine 20 provides the rendered digital image 22 at a particular rendered image resolution, in a form that is appropriate for communicating to a digital printer 40. (Image resolution is typically specified by a number of dots per inch (dpi).) For the case where the image resolution of the input digital image 12 is higher than the rendered image resolution of the rendered digital image 22, the rendering engine 20 engine applies a resizing operation which downsizes the image data. The rendering engine 20 may also apply a variety of other image processing operations including sharpening and anti-aliasing.

As noted earlier, downsizing the image data can result in various aliasing artifacts such as “jaggies” on the edges of text and line graphics. For example, the input digital image 12 may include a diagonal line sampled at an input image resolution (e.g., 1200 dpi) as shown in magnified input image data 14. Magnified rendered image data 24 illustrates the case where the rendered image resolution is half of the input image resolution. It can be seen that the rendered diagonal line has an increased degree of jaggedness characterized by jaggies 25.

In some embodiments, the input digital image 12 may be represented using a vector graphic representation rather than an array of input image pixels. In this case, the rendering engine 20 will generally include the step of forming a bitmap representation of the image data at the appropriate rendered image resolution.

Typically, the color channels of the input digital image 12 are the same as the color channels of the rendered digital image 22. However, in some cases the rendering engine 20 may apply a color transformation such that the rendered digital image 22 can have different color channels than the input digital image 22.

A printer driver 30 is used to format the image data for the rendered digital image 22 and control its transmission to the digital printer 40. The data transmission between the host computer 10 and the digital printer 40 can use any means known in the art including transmission over a communication link 35. The communication link 35 can be either wired communication link (e.g., a USB cable) or a wireless communication link (e.g., a WiFi connection). The communication link 35 will have an associated communication bandwidth which determines the rate at which data can be transmitted from the host computer 10 to the digital printer 40. The communications bandwidth for wireless communication links is generally much smaller than for wired communication links, which can impose significant limitations on the printing performance in some cases.

A printer controller 50 in the digital printer 40 accepts the image data and stores the image data in a memory buffer 60 that buffers the data for printing. A processor 70 reads the stored image data, formats it for print output, and directs the image data to a printhead 80. The printhead 80 contains the marking hardware (e.g., ink jet nozzles and support components) used to produce a printed image on a receiver 90.

For lower cost printers, such as desktop and all-in-one (AIO) devices, there can be performance constraints with the arrangement of FIG. 1. One limitation on performance is a result of wireless transmission between the host computer 10 and the digital printer 40. Digital images can be of significant size, and the bandwidth of the wireless communication link limits how quickly the image data can be transmitted to the digital printer 40. Another limitation relates to the computational speed of the processor 70. Due to cost constraints, the computational speed of the processor 70 selected for use in the digital printer 40 is often limited, which can impose a limitation on the speed at which the received image data can be processed and printed. This can be a particular problem where extensive processing must be applied to the image data. Processing unit 70 in the printer may not have the time or resources for providing anti-aliasing to correct for the aliasing problem.

FIG. 2A shows a logic flow diagram showing some elements of a conventional data processing path that can be used within the context of the printing system architecture shown in FIG. 1, which includes a host computer 10 and a digital printer 40. The input digital image 12 has an input resolution associated with the input image data. The input resolution may correspond to the native resolution of an image capture device, or it may correspond to the image resolution provided by a particular host application. Typically, the interface for the digital printer 40 requires image data of a particular resolution, which may be different than the input resolution. In order to provide image data at the required resolution, the rendering engine 20 (FIG. 1) applies a resize image step 185 forming a printer-resolution image 190 at a specified printer resolution. It should be noted that the printer resolution is not necessarily equivalent to the resolution of any physical printing elements (e.g., nozzles/inch of ink jet nozzles in an ink jet printhead). Rather the printer resolution corresponds to the resolution of the image data that the digital printer 40 is adapted to print. Often the printer resolution is specified by an interface specification for the printing system which defines the expected characteristics of the image data to be supplied at a certain point in the imaging chain. The printer resolution may be higher or lower that the resolution of the physical printing elements associated with the digital printer 40 depending on the printing system architecture.

The printer-resolution image 190 is then transmitted to the digital printer 40 over the communication link 35, providing received printer-resolution image 195, which can be stored in the memory buffer 60 (FIG. 1). A print image step 165 is then used to apply various processing steps to prepare the received printer-resolution image 195 for printing (using the processor 70 shown in FIG. 1) and to print the image data (using the printhead 80 shown in FIG. 1). As will be recognized by one skilled in the art, the processing performed by the rendering engine 20 and the processor 70 will generally include additional processing steps such as color correction, sharpening, halftoning and print masking. However, those steps have been omitted from FIG. 2A because they are not critical to the understanding of the present invention.

Digital printers 40 typically have printer resolutions of 600 dpi or greater. As a result, the printer-resolution image 190 can be quite large, and can take a significant amount of time to transmit across the communication link 35. This can impose a significant limitation on the throughput of the printing process, particularly when the communication link 35 is a wireless communication link. To improve the throughput, an optional compress image data step 125 can be used to apply a data compression algorithm in order to reduce the amount image data that needs to be transmitted over the communication link 35. A corresponding decompress image data step 130 is then applied in the digital printer 40 to reconstruct the received printer-resolution image 195. Any compression algorithm known in the art can be used for this purpose including the well-known JPEG and JBIG compression algorithms.

The configuration shown in FIG. 2A has the advantage of reducing the amount of processing that needs to be applied in the digital printer 40 since the image data is supplied at the printer resolution. It is also advantageous with respect to image quality. However, even when the compress image data step 125 is used, the amount of data that must be transmitted over communication link 35 from host computer 10 to digital printer 40 can be significant. As a result, slow transmission speed can be a significant drawback with the FIG. 2A arrangement, particularly where communication link 35 is a wireless communication link.

The logic flow diagram of FIG. 2B shows an alternate conventional approach that is designed to address the speed problem. In this arrangement, a downsize image step 105 is used to process the input digital image 12 to form a low-resolution image 110. An optional compress image data step 125 compresses the low-resolution image 110 for transmission to the digital printer 40 over the communication link 35. The decompress image data step 130 decompresses the image data to provide a received low-res image 135. A resize image step 145 then generates a high-resolution image 150 at the printer resolution. The print image step 165 then prints the image data.

The configuration shown in FIG. 2B is advantaged over the solution of FIG. 2A relative to the data transmission speed, since only a low-resolution image is provided to digital printer 40. However, image quality suffers, since information is discarded by the downsize image step 105, producing aliasing artifacts such as jaggies.

The logic flow diagram of FIG. 2C shows another conventional approach that attempts to mitigate the image quality losses associated with the FIG. 2B configuration. The processing applied in the host computer 10 is the same as that provided in the FIG. 2B arrangement. In this configuration, an anti-aliasing step 155 is applied to the high-resolution image 150, providing an anti-aliased image 160 that is printed in print image step 165. Anti-aliasing algorithms are well-known in the art, and are used to reduce aliasing artifacts such as jaggies.

The arrangement shown in FIG. 2C exhibits the same improved image transmission speed as was obtained using the FIG. 2B configuration. However, the use of the anti-aliasing step 155 can provide a significant image quality advantage over the FIG. 2B configuration. However, the anti-aliasing step 155 is typically a computation-intensive operation. As a result, the FIG. 2C arrangement will typically be disadvantaged relative to time required to process the image data in the digital printer 40. This can be particularly significant due to the fact that the processors 70 (FIG. 1) used in digital printers 40 generally have a relatively slow processing speed due to cost constraints. In some cases, the longer processing times required to apply the anti-aliasing algorithm can nullify the speed improvements realized by transmitting the low-resolution image 110. To minimize this disadvantage, the digital printer 40 could be provided with a more powerful processor 70; however, this solution has a cost impact that can prevent the printer from being a competitive product in a cost-sensitive market.

A number of conventional approaches have been disclosed for more efficient internal handling and processing techniques for images within a printer that benefit from additional information about image contents. For example, U.S. Pat. No. 7,414,757 to Eldridge et al., entitled “Method for compressing printing hint data sent to a printer,” describes a system that compresses image data and information related to image data for transfer between printer rendering and output subsystems, thereby reducing the amount of memory that the printer needs to store both the image and its auxiliary data and helping to compensate for compression artifacts in the image data itself.

U.S. Pat. No. 7,382,494 to McElvain, entitled “Method for tag plane growth and contraction for improving object edge rendering,” describes use of a supplemental tag plane as part of the image data that is processed within a printer for anti-aliased text and line art pixels, especially suited for reversed text characters.

Anti-aliasing presents a particular problem for printers that receive image data that has been rendered on an external host computer 10. As has been noted, complications result from differences in rendering resolution for different types of host processors, from the need to reduce the amount of data transferred, and from the need to provide an output print that has high quality text, line art, and graphics in a timely manner.

### SUMMARY OF THE INVENTION

The present invention represents a method for printing low-resolution digital image data received from a host computer on a digital printer, comprising:

receiving, on the digital printer, low-resolution image data transmitted from a host computer, wherein a data processor on the host computer formed the low-resolution image data by resizing full-resolution image data;

receiving, on the digital printer, mask image data transmitted from the host computer, wherein a data processor on the host computer formed the mask image data by automatically analyzing the full-resolution image data or the low-resolution image data, the mask image data providing an indication of image regions in the low resolution image data that would benefit from the application of an anti-aliasing algorithm;

using a data processor in the digital printer to resize the low-resolution image data, forming high-resolution image data at a higher resolution than the low-resolution image data;

using the data processor in the digital printer to apply an anti-aliasing method to portions of the high-resolution image data corresponding to the indicated image regions in the mask image data, thereby providing anti-aliased image data; and

printing the anti-aliased image data on the digital printer.

This invention has the advantage that it provides anti-aliasing information for transmitted image content, allowing the printer to efficiently correct for aliasing artifacts.

This invention has the additional advantage that it allows for transfer of a low amount of image data while still generating a high-quality output image.

It has the further advantage that the printer only needs to apply the anti-aliasing algorithm to a subset of the image data, thereby reducing the amount of processing time needed to determine the anti-aliased image data.

### BRIEF DESCRIPTION OF THE DRAWINGS

FIG. 1 is a schematic diagram showing components of a conventional system for printing digital image data including host computer and a digital printer in communication with the host computer;

FIG. 2A is a logic flow diagram associated with a first prior art method for printing image data on a digital printer;

FIG. 2B is a logic flow diagram associated with a second prior art method for printing image data on a digital printer where low-resolution image data is transmitted to the digital printer;

FIG. 2C is a logic flow diagram associated with a third prior art method for printing image data on a digital printer where low-resolution image data is transmitted to the digital printer and an anti-aliasing method is applied to the transmitted low-resolution image data;

FIG. 3 is a schematic diagram showing components of a system for printing digital image data including host computer and a digital printer in communication with the host computer according to an embodiment of the present invention;

FIG. 4 is a logic flow diagram associated with a method for printing image data on a digital printer according to one embodiment of the present invention;

FIG. 5A shows an array of pixels that can be used for a morphological anti-aliasing method;

FIG. 5B shows a partial set of L-shaped pixel patterns that can be used for pattern detection in one embodiment of a morphological anti-aliasing method;

FIG. 5C shows a set of image pixel patterns that are matches to the L-shaped pixel patterns of FIG. 5B;

FIG. 5D shows anti-aliased image pixel patterns corresponding to the image pixel patterns of FIG. 5C; and

FIG. 5E shows a set of image pixel patterns that do not match the L-shaped pixel patterns of FIG. 5B.

It is to be understood that the attached drawings are for purposes of illustrating the concepts of the invention and may not be to scale.

### DETAILED DESCRIPTION OF THE INVENTION

In the following description, some embodiments of the present invention will be described in terms that would ordinarily be implemented as software programs. Those skilled in the art will readily recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, together with hardware and software for producing and otherwise processing the image signals involved therewith, not specifically shown or described herein may be selected from such systems, algorithms, components, and elements known in the art. Given the system as described according to the invention in the following, software not specifically shown, suggested, or described herein that is useful for implementation of the invention is conventional and within the ordinary skill in such arts.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

In the context of the present disclosure, the term “host computer” is used to encompass a broad range of possible devices that can generate image data for printing. Examples of such devices include mainframe computers, computer workstations, personal computers, cameras (including camera devices incorporated into cell phone and other communication devices), document scanning apparatus, personal digital assistants (PDAs), and numerous other handheld or portable devices, as well as desktop and instrumentation devices. Of particular relevance is any type of device having a logic processor and generating text or line art image elements that benefit from anti-aliasing when printed at various output resolutions. The term “digital printer” or simply “printer” has its conventional meaning and can relate to digital printing devices that utilize various marking technologies to print received digital image data, such as inkjet printers, thermal printers, or electrophotographic printers, for example.

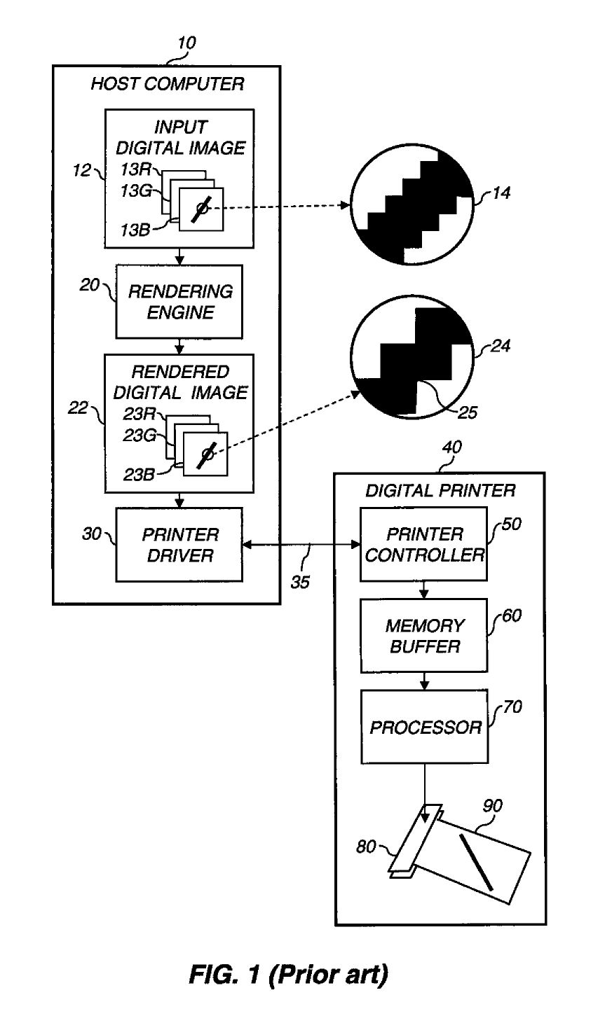

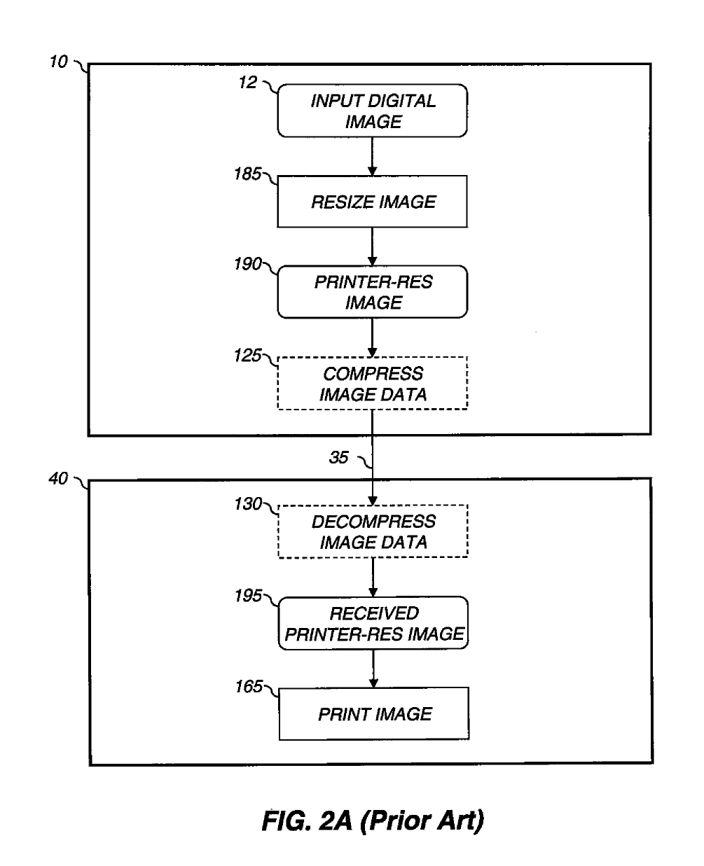

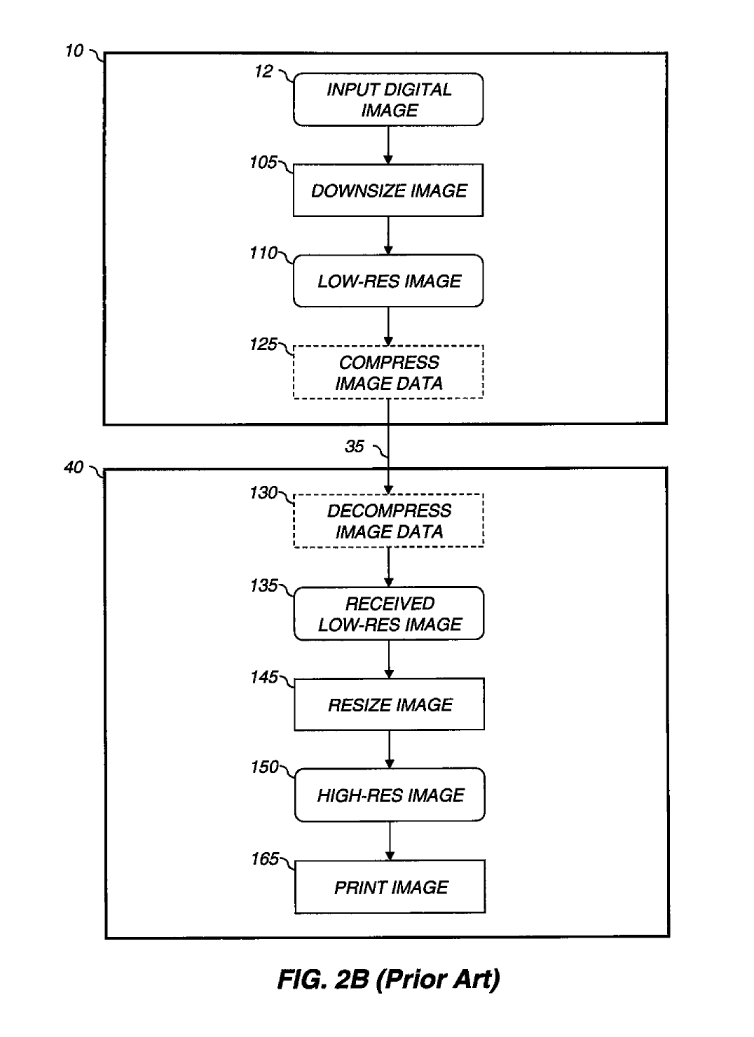

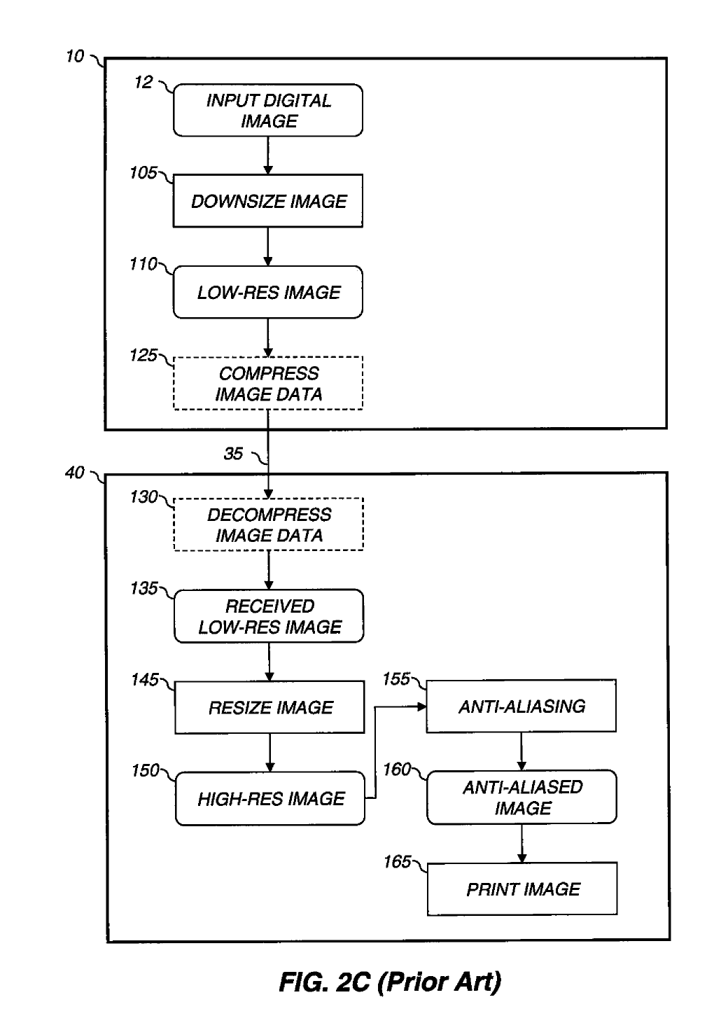

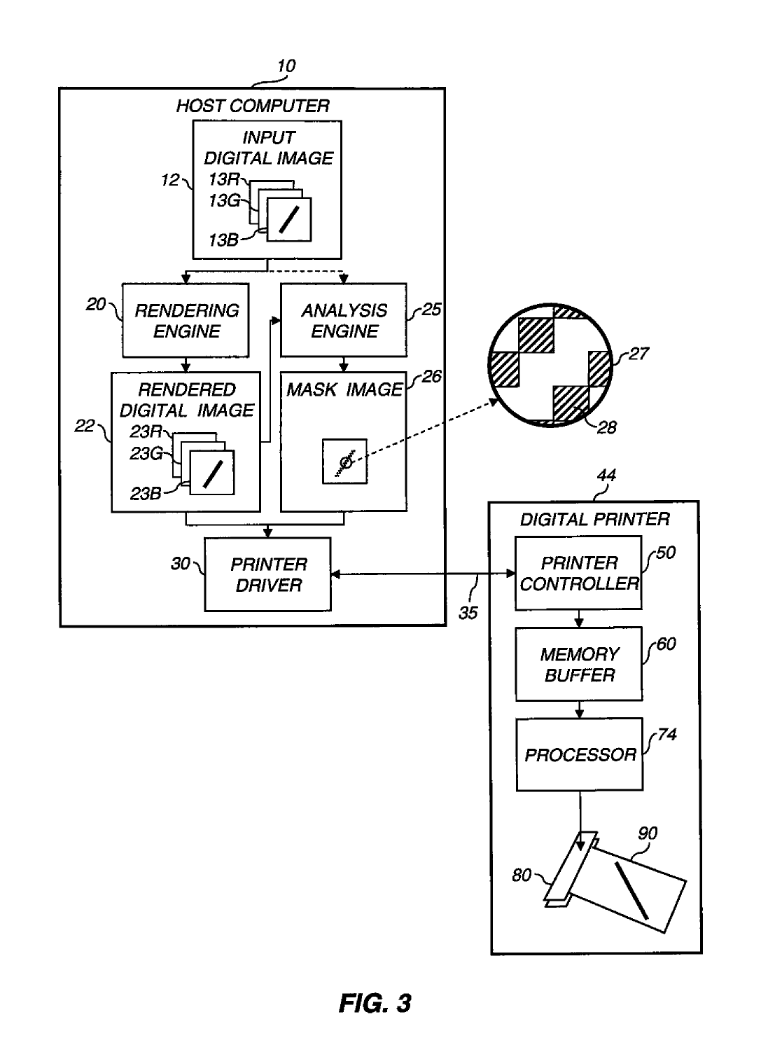

The present invention will now be described with reference to the schematic diagram of FIG. 3, which shows an arrangement of components for a representative printing system architecture that is configured to deliver fast print speeds while providing improved image quality through the application of an anti-aliasing algorithm. Components that are analogous to those shown in FIG. 1 are labeled with the same reference numbers.

As described with respect to FIG. 1, At the host computer 10, the input digital image 12 is processed by the rendering engine 20 to provide the rendered digital image 22. The rendered digital image 22 is transmitted to a digital printer 44 over the communication link 35, which can be either wired or wireless as discussed earlier. In order to provide fast printing speeds, and in particular to provide fast data transmission speeds over the communication link 35 between the host computer 10 and the digital printer 44, the processing applied by the rendering engine 20 includes the step of resizing the input digital image 12 to provide low-resolution image data for the rendered digital image 22 at a specified resolution level (e.g., 300 dpi). In general, the resizing operation will downsize the input digital image 12 to provide a reduced resolution, although in some cases the resizing operation might upsize the input digital image 12 if it has an input resolution less than the specified resolution level. In one embodiment, the input digital image 12 is provided by software running on the host computer at a predefined resolution (e.g., 600 dpi) and the resizing operation reduces the resolution by a factor of 2×, thereby reducing the amount of image data that must be transmitted to the digital printer 44 by a factor of 4×.

An analysis engine 25 is used to determine mask image data for a mask image 26. The mask image provides an indication of image regions in the rendered digital image 22 that would benefit from the application of an anti-aliasing algorithm. In a preferred embodiment, the analysis engine 25 determines the mask image 26 by automatically analyzing the rendered digital image to identify image pixels that are susceptible to aliasing artifacts such as jaggies. Optionally, the analysis engine 25 can determine the mask image 26 by automatically analyzing the input digital image 12 rather than the rendered digital image 22.

In a preferred embodiment, the mask image 26 contains hint pixels 28 as shown in the magnified mask image data 27, which provide an indication of the particular pixels that should be processed with an anti-aliasing algorithm. As will be described in more detail later, the mask image 26 can be encoded in a variety of different ways in accordance with the present invention. The mask image 26 can be provided at either full-resolution of the input digital image or the low-resolution of the rendered digital image 22. In other configurations, the mask image 26 can be provided at a resolution corresponding to the high resolution image data that will be described later.

Still referring to FIG. 3, the digital printer 44 is configured to receive the low-resolution rendered digital image 22, together with the mask image 26, over the communication link 35. The printer driver 30 on the host computer 10 will generally be used to format the data for transmission, and the printer controller 50 on the digital printer 44 receives the data and stores it in the memory buffer 60.

A processor 74 is used to process the received image data to prepare in for printing onto receiver 90 using printhead 80. The processor 74 includes an associated program memory that stores encoded instructions for causing the processor 74 to resize the received low-resolution image data to form high-resolution image data. In a preferred embodiment, the high-resolution image data is at the printer resolution, the printer resolution corresponding to the resolution of the image data that the digital printer 40 is adapted to print.

The program memory also stores encoded instructions for causing the processor 74 to apply an anti-aliasing algorithm to portions of the high-resolution image data according to the image regions indicated by the received mask image data. The present invention has the advantage that the processor 74 only needs to apply the anti-aliasing algorithm to a subset of the image data, thereby reducing the amount of processing time needed to determine the anti-aliased image data. This is particularly significant due to the fact that processors 74 selected for use in digital printers 44 generally have a relatively low processing speed in order to reduce the cost of the digital printer 44. The processor 74 will generally also includes encoded instructions for performing a variety of other operations such as color correction, halftoning, print masking and data formatting.

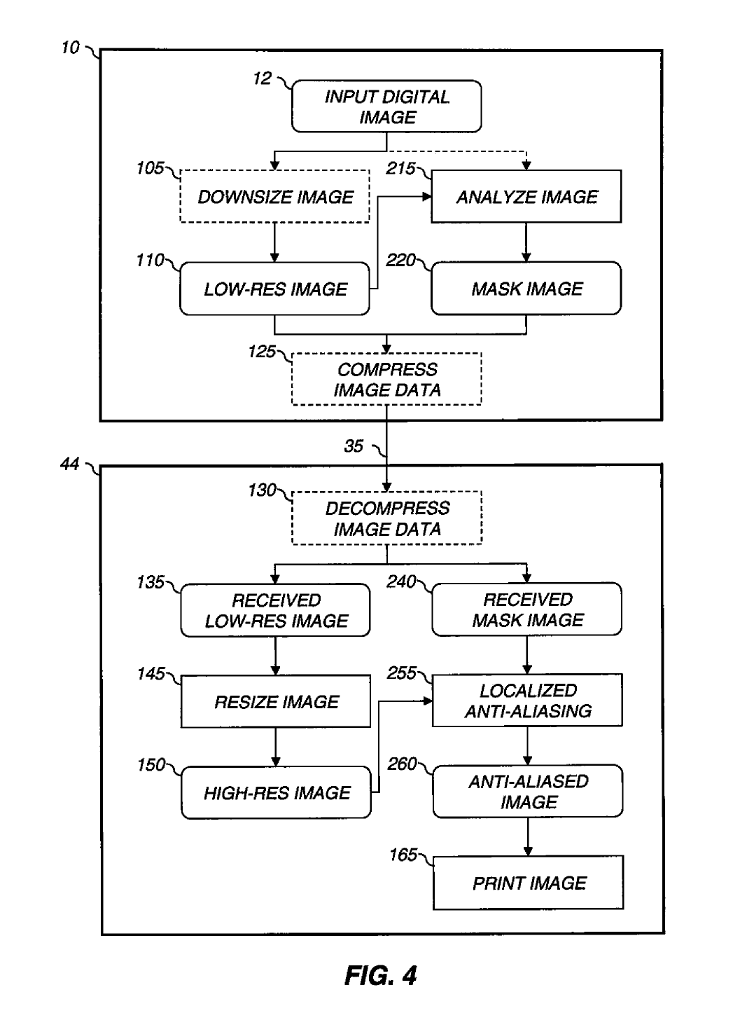

The logic flow diagram of FIG. 4 shows the sequence of steps and processing output provided at host computer 10 and digital printer 44 to provide an anti-aliased image according to one embodiment. Input digital image 12 is processed with an optional downsize image step 105 to generate a low-resolution image 110 at some predefined image resolution (e.g., 300 dpi). As noted previously, in some embodiments this processing can be a downsizing of the image by a factor of 2× in both the horizontal and vertical dimensions. If the input digital image 12 is already at the predefined image resolution, the downsize image step 105 can be skipped. Alternately, if the input digital image 12 is at a lower image resolution, it may be necessary to apply an image upsizing step.

The downsize image step 105 can use any method for reducing the size of an image known in the art. In one embodiment, a simple “nearest neighbor” interpolation method can be used. For the case of a 2× downsizing, this simply involves discarding alternate rows and columns of the image data. Alternately, other types of interpolation can be used such as bilinear or bicubic. In some embodiments, a convolution operation can be applied to pre-filter the image data before applying the downsizing operation. This is well-known in the art to reduce the magnitude of aliasing artifacts.

An analyze image step 215 then analyzes the image content to determine a mask image 220 that identifies image regions that would benefit from the application of an anti-aliasing algorithm. In a preferred embodiment, the mask image 220 is provided at the same resolution as the low-resolution image 110, but this is not a requirement. It will be obvious to one skilled in the art that the mask image data could be supplied at some other resolution. For example, the mask image 220 can be supplied at a lower resolution to minimize the amount of additional data that needs to be transmitted over the communication link 35 at the expense of only being able to specify the anti-aliasing image regions on a coarser scale.

The mask image 220 can be encoded in a variety of different forms in accordance with the present invention. For example, the mask image 220 can be encoded as a separate image file from the low-resolution image 100. Alternately, it can be encoded as an additional image plane that is stored together with the low-resolution image 110. In one embodiment, the mask image data is encoded using a particular bit in a multi-bit image plane, wherein other information is encoded in other bits of the multi-bit image plane. For example, an indication of the object type (text, graphics, bitmap image or white space) for each image pixel can be stored using a 3-bit code of an 8-bit image plane. The mask image data can then be stored using one of the unused bits in the 8-bit image plane. Alternately, the mask image 220 can be encoded with the image data in some other manner. For example, in one embodiment mask image 220 uses available extra bits in one of the image planes in the low-resolution image 110, where these extra bits are not used for pixel data values. Alternately, the mask image 220 can be provided as a list of pixel addresses specifying the image pixels that are to be processed using an anti-aliasing algorithm.

The low-resolution image 110 and the mask image 220 are transmitted to the digital printer 44 over the communication link 35 (either wired or wireless). In some embodiments, the host computer 10 applies an optional compress image data step 125 to compress both the low-resolution image 110 and mask image 220, thereby reducing the amount of data that needs to be transmitted across the communication link 35. The compress image data step 125 can use any data compression algorithm known in the art to compress the image data, such as the well-known JPEG or JBIG compression algorithms. At digital printer 44, a corresponding decompress image data step 130 is used to decompress the compressed image data to provide a received low-resolution image 135 and a received mask image 240.

The resize image step 145 resizes the received low-resolution image 135 to form high-resolution image 150. The resize image step 145 can use any method for resizing images known in the art. In a preferred embodiment, simple pixel replication is used to increase the image size by an integer multiple (e.g., 2×). In alternate embodiments, other methods for resizing images can be used such as bilinear interpolation or bicubic interpolation.

A localized anti-aliasing step 255 then performs anti-aliasing on high-resolution image 150 to provide an anti-aliased image 260, which is subsequently printed using the print image step 165. The localized anti-aliasing step 255 only performs anti-aliasing to portions of the high-resolution image 150 corresponding to the indicated image regions in the received mask image 240. This has the effect of reducing the processing time required to gain the image quality advantages of applying an anti-aliasing algorithm to the high-resolution image 150.

The print image step 165 generally includes the application of a number of standard image processing operations before the image data is ready to be printed using the printhead 80 (FIG. 3). Typical image processing operations would include color correction/calibration, an additional resizing operation, halftoning and print masking, for example. The details of such image processing operations are well-known to those skilled in the art.

Advantageously, the apparatus and methods shown and described with reference to FIGS. 3 and 4 allow a digital printer to receive rendered image data from host print drivers on many types of host computer devices. For example, this allows the use of a digital printer from one manufacturer with a host computer from a different manufacturer. Methods and apparatus of the present invention allow increased independence of the printer hardware from constraints imposed by the host computer, while taking advantage of the processing capability of the rendering engine at the host computer. Using the present invention, anti-aliasing is supported for files originated at a host computer without constraining the printer output to a particular resolution. Printer processing hardware does not require high-cost, high-performance components to perform anti-aliasing, since the mask image information already directs processing activity to specific regions of the image. Transmission of image data and mask image data can be done over a wireless or wired communication link.

The localized anti-aliasing step 255 can use any anti-aliasing method known in the art to determine the anti-aliased image 260. As is well-known to those skilled in the art, anti-aliasing algorithms are useful for the smoothing of jagged edges (jaggies) for text and line art, as well as other similar image elements that contain sharp edge transitions between the color of the image element and its background. Anti-aliasing methods adjust pixel values for pixels along the edges of the imager element to provide a smoother edge and a more gradual transition between the image element and its background. An example of an anti-aliasing method that can be used in accordance with the present invention is given in U.S. Pat. No. 7,542,174 to Chien, entitled “Image processing method for reducing jaggy effect,” which describes a specific method for specifying replacement edge pixels.

Many examples of anti-aliasing methods involve the use of morphological filters; these methods will be referred to as morphological anti-aliasing methods. (For example, see the article “Morphological Antialiasing,” by A. Reshetov, in Proc. ACM Symposium on High Performance Graphics, pp. 109-116, 2009.) Morphological anti-aliasing methods generally specify one or more reference patterns of pixels that are characteristic of jagged edges. The reference patterns are compared to the image data to identify matching patterns of pixels along the edges of text or line art. An appropriate smoothing method can then be used to smooth the pixel values in the identified regions.

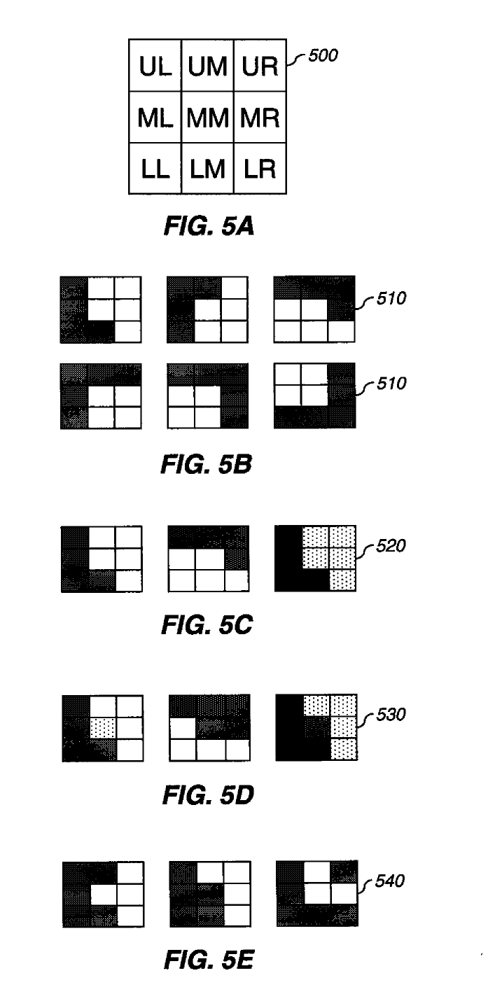

FIGS. 5A-5D show various features and relationships for using reference patterns of pixels to as part of a morphological anti-aliasing method according to one embodiment. As shown in FIG. 5A, a 3×3 array of pixels 500 has nine pixel elements labeled UL (upper left), UM (upper center), UR (upper right), ML (middle left), MM (middle center), MR (middle right), LL (lower left), LM (lower center), and LR (lower right).

FIG. 5B shows a partial set of L-shaped pixel patterns 510 that can be used for pattern detection according to this anti-aliasing method. Here, a match is detected when a particular L-shaped pixel pattern 510 aligns with a corresponding L-shaped pattern in the image data. More specifically, a match is detected if the image pixels corresponding to the dark pixels in the particular L-shaped pixel pattern 510 have the same color (i.e., their pixel values fall within a predetermined range); the image pixels corresponding to the light pixels in the particular L-shaped pixel pattern 510 have the same color (i.e., their pixel values fall within a predetermined range); and dark pixels are darker than the light pixels (i.e., they are darker by a difference greater than a predetermined threshold).

FIG. 5C shows a number of different image pixel patterns 520 which match of one of the L-shaped pixel patterns 510 shown in FIG. 5B. By way of contrast, FIG. 5E shows a few of many image pixel patterns 540 that would not match any of the L-shaped pixel patterns 510 in FIG. 5B.

When a match is found between an image pixel pattern 520 and an L-shaped pixel patterns 510, the pixel value for the center pixel MM in the image pixel pattern 520 is recalculated to provide an anti-aliased pattern. In one embodiment, the new value is calculated by determining an average of the lighter and darker pixel values. Since the pixels that are considered light and dark within the respective pixel regions can vary by up to some specified threshold value, the average pixel value of the pixels within the pixel regions can be used. Optionally, a scaling factor can be applied to bias the new code value toward the lighter or darker pixel value. For example, the new code value for the center pixel (MM) can be calculated using the following equation:

CV_{new}=ave(CV_{dark})+K(ave(CV_{light})−ave(CV_{dark}))

where CV_{new} is the new code value for the center pixel, CV_{dark} are the code values of the dark image pixels, CV_{light} are the code values of the light image pixels, K is a constant (generally between 0 and 1) and ave(·) represents an average operation applied to the pixel values for a pixel region. If K=0.5, the new code value is the average of the dark and light code values; if K<0.5, the new code value will be biased toward the dark code values; and if K>0.5, the new code value will be biased toward the light code values. FIG. 5D shows anti-aliased image pixel pattern 530 determined by applying anti-aliasing correction to the image pixel patterns 520 in FIG. 5C.

In one embodiment of the present invention, the analyze image step 215 performs the pattern matching portion of the anti-aliasing method on the host computer 10 to identify pixels that match one of the L-shaped pixel patterns 510. The mask image 220 then stores an indication of which pixels should be processed to calculate new code values. The localized anti-aliasing step 255 applied in the digital printer 44 then performs the step of calculating the new code values for the image regions indicated by the received mask image 240.

In other embodiments, the analyze image step 215 may use some other method to identify image regions that would benefit from the application anti-aliasing method. For example, the analyze image step can use an edge detection operation to identify high contrast edges in the input digital image. The localized anti-aliasing step 255 then performs both the pattern matching and correction portions of the anti-aliasing method for the image regions indicated by the received mask image 240.

In the context of the present disclosure, the term “memory” is used as a general term to encompass non-transitory tangible computer readable storage medium of both non-volatile and volatile types. A computer program product can include one or more types of storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed as a program memory to store a computer program having instructions for controlling one or more computers to practice the method according to the present invention. With respect to the exemplary digital printer architecture shown in FIG. 3, program memory can be stored within rendering engine 20, analysis engine 25, printer driver 30, printer controller 50 or processor 74, for example, or stored in a processor-accessible memory that is in communication with components of the host computer 10 or the digital printer 44.

The invention has been described in detail with particular reference to certain preferred embodiments thereof, but it will be understood that variations and modifications can be effected within the spirit and scope of the invention.

### PARTS LIST

10 host computer
12 input digital image
13R red input image plane
13G green input image plane
13B blue input image plane
14 magnified input image data
20 rendering engine
22 rendered digital image
23R red rendered image plane
23G green rendered image plane
23B blue rendered image plane
24 magnified rendered image data
25 jaggie
26 mask image
27 magnified mask image data
28 hint pixel
30 printer driver
35 communication link
40 digital printer
44 digital printer
50 printer controller
60 memory buffer
70 processor
74 processor
80 printhead
90 receiver
105 downsize image step
110 low-resolution image
125 compress image data step
130 decompress image data step
135 received low-res image
145 resize image step
150 high-resolution image
155 anti-aliasing step
160 anti-aliased image
165 print image step
185 resize image step
190 printer-resolution image
195 received printer-resolution image
215 analyze image step
220 mask image
240 received mask image
255 localized anti-aliasing step
260 anti-aliased image
500 array of pixels
510 L-shaped pixel pattern
520 image pixel pattern
530 anti-aliased image pixel pattern
540 image pixel pattern

1. A method for printing low-resolution digital image data received from a host computer on a digital printer, comprising:
receiving, on the digital printer, low-resolution image data transmitted from a host computer, wherein a data processor on the host computer formed the low-resolution image data by resizing full-resolution image data;
receiving, on the digital printer, mask image data transmitted from the host computer, wherein a data processor on the host computer formed the mask image data by automatically analyzing the full-resolution image data or the low-resolution image data, the mask image data providing an indication of image regions in the low resolution image data that would benefit from the application of an anti-aliasing algorithm;
using a data processor in the digital printer to resize the low-resolution image data, forming high-resolution image data at a higher resolution than the low-resolution image data;
using the data processor in the digital printer to apply an anti-aliasing method to portions of the high-resolution image data corresponding to the indicated image regions in the mask image data, thereby providing anti-aliased image data; and
printing the anti-aliased image data on the digital printer.

2. The method of claim 1 wherein the low-resolution image data and the mask image data are received from the host computer in a compressed form, and wherein a decompression algorithm is applied using the data processor in the digital printer in order to decompress the compressed low-resolution image data and the compressed mask image data.

3. The method of claim 1 wherein the mask image data is received in the form of an additional image plane associated with the low-resolution image data.

4. The method of claim 1 wherein the mask image data is encoded using a particular bit in a multi-bit image plane, wherein other information relevant to the low-resolution image data is encoded in other bits of the multi-bit image plane.

5. The method of claim 1 wherein the mask image data is received at the same resolution as the low-resolution image data.

6. The method of claim 1 wherein the anti-aliasing algorithm is a morphological anti-aliasing algorithm.

7. The method of claim 1 wherein the low-resolution image data is formed by applying a sub-sampling method to the full-resolution image data.

8. The method of claim 1 wherein the low-resolution image data is formed by applying an interpolation method to the full-resolution image data.

9. The method of claim 1 wherein the low-resolution image data and the mask image data is received over a wireless communication link or a wired communication link.

10. A method for printing low-resolution digital image data received from a host computer on a digital printer, comprising:
receiving on the digital printer, low-resolution image data transmitted from a host computer;
receiving on the digital printer, mask image data transmitted from the host computer, wherein a data processor on the host computer formed the mask image data by automatically analyzing the low-resolution image data, the mask image data providing an indication of image regions that would benefit from the application of an anti-aliasing algorithm;
using a data processor in the digital printer to resize the low-resolution image data forming high-resolution image data at a higher resolution than the low-resolution image data;
using the data processor in the digital printer to apply an anti-aliasing algorithm to portions of the high-resolution image data corresponding to the indicated image regions in the mask image data, thereby providing anti-aliased image data; and
printing the anti-aliased image data on the digital printer.

11. The method of claim 10 wherein the low-resolution image data and the mask image data are received from the host computer in a compressed form, and wherein a decompression algorithm is applied using the data processor in the digital printer in order to decompress the compressed low-resolution image data and the compressed mask image data.

12. The method of claim 10 wherein the mask image data is received in the form of an additional image plane associated with the low-resolution image data.

13. The method of claim 10 wherein the mask image data is encoded using a particular bit in a multi-bit image plane, wherein other information relevant to the low-resolution image data is encoded in other bits of the multi-bit image plane.

14. The method of claim 10 wherein the mask image data is received at the same resolution as the low-resolution image data.

15. The method of claim 10 wherein the anti-aliasing algorithm is a morphological anti-aliasing algorithm.

16. The method of claim 10 wherein the low-resolution image data and the mask image data is received over a wireless communication link or a wired communication link.

17. A method for printing digital image data received from a host computer on a digital printer, comprising:
receiving, on the digital printer, image data transmitted from a host computer;
receiving, on the digital printer, mask image data transmitted from the host computer, wherein a data processor on the host computer formed the mask image data by automatically analyzing the image data, the mask image data providing an indication of one or more image regions that would benefit from the application of an anti-aliasing algorithm;
using a data processor in the digital printer to resize the received image data, forming printer-resolution image data;
using the data processor in the digital printer to apply an anti-aliasing algorithm to portions of the printer-resolution image data corresponding to the indicated image regions in the mask image data, thereby providing anti-aliased image data; and
printing the anti-aliased image data on the digital printer.

18. A method for printing digital image data, the method comprising:
receiving rendered image data at a first resolution and receiving mask image data corresponding to the rendered image data, the mask image data being indicative of one or more image regions in the rendered image data identified for anti-aliasing;
resizing the received rendered image data to form resized image data at a second resolution that is higher than the first resolution;
forming anti-aliased print image data by applying an anti-aliasing process to at least one image region of the resized image data according to the received mask image data; and
printing onto a receiver medium according to the anti-aliased print image data.

19. A digital printer for printing low-resolution digital image data received from a host computer, comprising:
a communication link for receiving data from a host computer;
a print engine for printing image data on a receiver;
a data processor;
a program memory containing executable instructions for causing the data processor to perform the steps of
receiving the low-resolution image data transmitted over the communication link from the host computer;
receiving printer mask image data transmitted over the communication link from the host computer, wherein a data processor on the host computer formed the mask image data by automatically analyzing the low-resolution image data, the mask image data providing an indication of image regions that would benefit from the application of an anti-aliasing algorithm;
resizing the low-resolution image data to form high-resolution image data at a higher resolution than the low-resolution image data;
applying an anti-aliasing algorithm to portions of the high-resolution image data corresponding to the indicated image regions in the mask image data, thereby providing anti-aliased image data; and
printing the anti-aliased image data using the print engine.
